(19) United States
(12) Patent Application Publication
(10) Pub. No.: US 2007/0157388 A1
(43) Pub. Date: Jul. 12, 2007

(54) Modular Bedding System Including Knock Down Modular Bed Base

(75) Inventors: Niels S. Mossbeck, Carthage, MO (US); Jacob J. Neuenswander, Carthage, MO (US); Thomas W. Wells, Joplin, MO (US)

Correspondence Address: WOOD, HERRON & EVANS, LLP, 2700 CAREW TOWER, 441 VINE STREET, CINCINNATI, OH, 45202, US

(73) Assignee: L&P PROPERTY MANAGEMENT COMPANY, South Gate, CA (US)

(21) Appl. No.: 11/421,199

(22) Filed: May 31, 2006

Related U.S. Application Data
(63) Continuation-in-part of application No. 11/329,998, filed on Jan. 11, 2006.

(51) Int. Cl. A61G 7/015; A47C 19/22

(52) U.S. Cl. 5/618; 5/201

(57) ABSTRACT

A modular bedding system comprises a universal knock down bed base having removable mattress supporting panels, a headrest adjustable module and a footrest adjustable module. The universal bed base may be used with the removable panels in place to support a conventional non-adjustable mattress or the removable panels may be removed and the adjustable modules substituted to enable the base to support either a headrest adjustable mattress or a headrest and footrest adjustable mattress.

### RELATIONSHIP TO OTHER PENDING PATENT APPLICATIONS

This application is a Continuation-in-Part application of application Ser. No. 11/329,998, filed Jan. 11, 2006 and entitled “Modular Bedding System Including Modular Bed Base”.

### FIELD OF THE INVENTION

This invention relates generally to bedding products and, more particularly, to a modular bedding system, including a knock down modular bed base or foundation for supporting non-adjustable, as well as adjustable, mattresses.

### BACKGROUND OF THE INVENTION

Prior to the advent of the bed base disclosed in the above-identified parent patent application, of which this application is a Continuation-in-Part, there existed in the marketplace bed bases or foundations for non-adjustable mattresses and bed bases or foundations for supporting adjustable mattresses. Those two different types of bed bases had nothing in common, either structurally or in terms of cost. The bed bases for adjustable mattresses were much more complex in structure and much more expensive than bed bases used to support non-adjustable mattresses. The bed bases for adjustable mattresses were generally manufactured and sold fully assembled, but sometimes were sold in pieces. Irrespective of whether sold fully assembled or in pieces, when applied to a queen size bed, those pieces were heavy and large, oftentimes so large that they were very difficult to transport to and through doorways, stairs, etc., of small apartments or homes.

In the above-identified parent patent application, there is disclosed a modular bedding system having a bed base which includes removable head and foot deck panels. The bed base there disclosed is so constructed that the removable head deck panel may be replaced by an articulating head section module, such that the bed, including the original base, may then function as a headrest adjustable bed. The foot removable deck panel of the bed base there disclosed may also be removed and replaced by an articulating adjustable foot section module, such that the foot section of the bed, still including the original base, is adjustable. According to the disclosure of this parent patent application, the adjustment of the headrest and footrest adjustable modules may be as simple as a ratchet mechanism for raising or tilting the head section or the foot section of the bed, or the modules may be independently motorized and controlled by a conventional hardwired hand wand or by a wireless remote.

The modular bedding system disclosed in the above-identified parent patent application has the advantage of enabling a bedding retailer to sell the modular bed base to a customer with a non-adjustable fixed mattress and then later upgrade that modular bed base by selling relatively inexpensive headrest or footrest adjusting modules at prices which are substantially lower than the current differential in price between non-adjustable beds and adjustable beds. That bedding system and bed base also had the advantage of enabling a bedding retailer to sell both adjustable and non-adjustable beds while maintaining a substantially lower inventory of products needed to serve both markets.

That bedding system and bed base also has the advantage, because the whole bedding system is modular, to be easily transported from a sale site to the customer and moved into and through stairways and doorways with minimal space clearance requirements.

But that bedding system still required the transport of a large bed base of assembled side boards and end boards which, in at least the queen or king size beds, could be unwieldy and expensive to ship. Accordingly, it has been an objective of this invention to provide a modular bedding system having a bed base suitable for supporting either a non-adjustable flat mattress or an adjustable mattress, but which incorporates a knock down base which is more easily and less expensively shipped than the bed base disclosed in the above-identified parent patent application.

Still another objective of this invention has been to provide a modular bedding system, including a modular bed base, which has all of the advantages of the modular bedding system disclosed in the above-identified parent patent application, but which includes a base which may be shipped disassembled, and then later assembled, preferably without the use of any tools.

### SUMMARY OF THE INVENTION

The knock down bedding base of this invention which accomplishes these objectives comprises two oppositely facing side boards and two oppositely facing end boards, all of which have inside surfaces, outside surfaces and top and bottom edges. Fittings are fixedly attached to the inside surface of the side boards and end boards which enable the end boards to be removably secured to the side boards without the use of any tools. Additionally, there are side board support rails attached to the inside surfaces of the side boards, the top surfaces of which are located beneath the top edge of the side boards. A center deck board extends between the side boards and rests atop the top surface of the side board support rails. Additionally, there are two cross rails having fittings secured to the opposite ends thereof which fit into fittings on the inside surface of the side boards so as to enable the cross rails to be removably attached to the side boards, again without the use of any tools. Removable head and deck panels rest atop the top surface of the side board rails so that these panels may be replaced by an adjustable head section module and an adjustable foot section module, respectively.

There are four feet which may be attached to the cross rails of the knock down bedding base, again without use of any tools.

In a preferred embodiment of the invention, there is a fabric loop which fits around the exterior of the side and end boards of the bedding base and which may be removably attached thereto by means of strips of Velcro® hook and loop material extending around at least the top of the inside surface of the side and end boards.

The advantages of this invention will become more readily apparent from the following description of the drawings, in which:

### BRIEF DESCRIPTION OF THE DRAWINGS

FIG. 1 is a perspective view of a bed base or foundation used in the practice of this invention and illustrating in phantom a mattress placed upon the top of the base;

FIG. 2 is an exploded perspective view of the bed base of FIG. 1;

FIG. 3 is a perspective view of the bed base of FIG. 1, but with a head deck panel replaced by an adjustable head section module;

FIG. 4 is a view similar to FIG. 3, but illustrating the foot deck panel replaced by an adjustable foot section module;

FIG. 5 is a perspective view of an adjustable head section module having the head deck panel supported by a conventional adjustable ratchet mechanism, the head deck panel of the module being illustrated in phantom;

FIG. 6 is a view similar to FIG. 5, but illustrating a motorized version of the head section module;

FIG. 7 is a perspective view of an adjustable motorized foot section module illustrating the leg and foot supporting boards of the module in phantom;

FIG. 8 is a perspective disassembled view of all of the components of the modular bed base portion of the bedding system;

FIG. 9 is an enlarged assembled perspective view of one end of a cross rail and supporting foot;

FIG. 10 is a perspective view of one end of a cross rail and one end of a side board illustrating how fittings on the end of the cross rail and side board are assembled;

FIG. 11 is a perspective view of one end of a board and one end of a side board illustrating how fittings on the ends of these boards are assembled;

FIG. 12 is a perspective view of a loop of fabric material partially assembled over the exterior of the assembled cross rails, side boards and end boards of the base frame;

FIG. 13 is an enlarged perspective view of a portion of the base frame shown in FIG. 12 and illustrating how the loop of fabric material is attached to the side and end boards of the base frame;

FIG. 14 is a perspective view of the assembled base frame preparatory to mounting of the center panel on the base frame; and

FIG. 15 is a perspective view similar to FIG. 14, but with the center panel mounted on the assembled base frame.

### DETAILED DESCRIPTION OF THE DRAWINGS

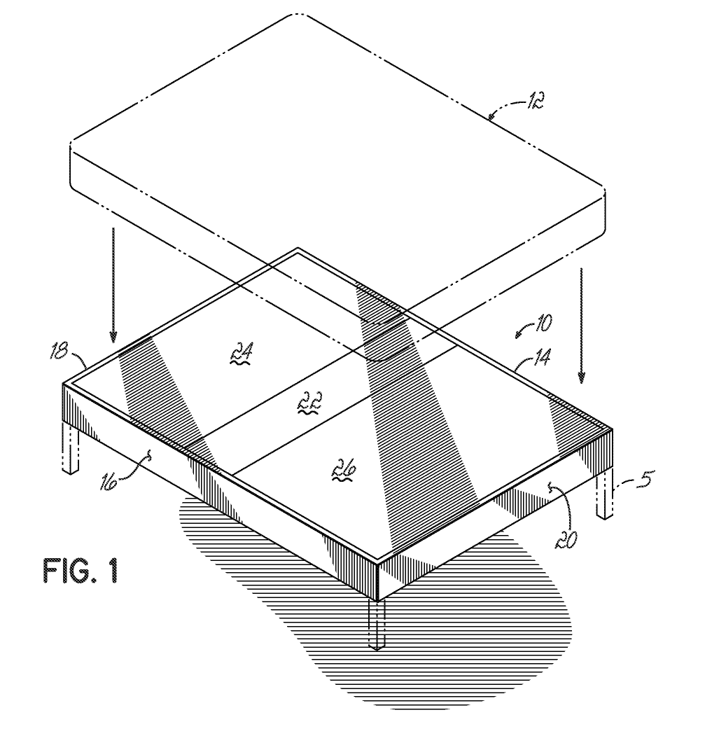

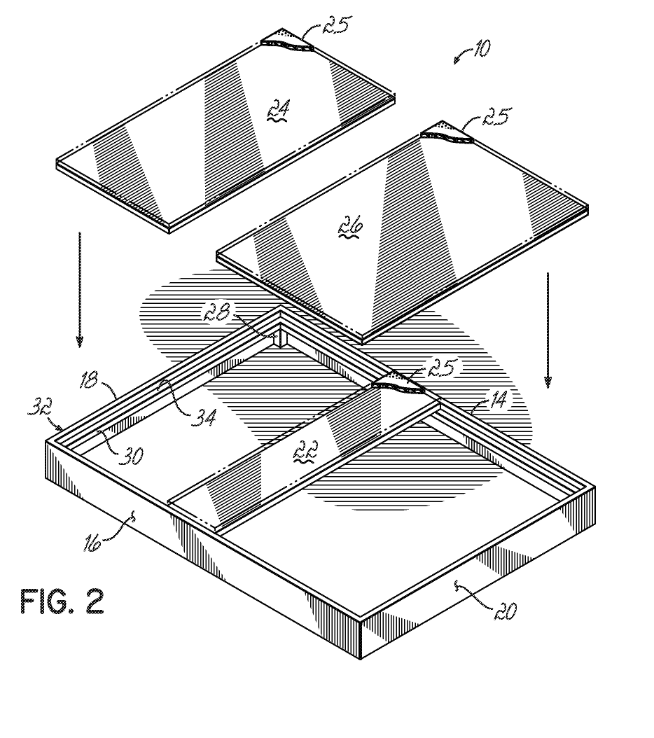

With reference first to FIGS. 1 and 2, there is illustrated a bed base or foundation 10 for supporting a mattress 12. The bed base 10 comprises two side boards 14, 16, a head end board 18, a foot end board 20, and a pair of cross rails 19, 21. The side boards and end boards form a rectangular perimeter frame operative to support a center deck board 22, as well as a removable head deck board or panel 24 and a removable foot deck board or panel 26. The center deck board, or panel 22, extends between the two side boards 14, 16 and as is explained more fully hereinafter, is preferably secured to them as opposed to being removable as are the head deck board 24 and foot deck board 26. As is explained more fully hereinafter, the side boards 14 and 16, as well as the head end board and foot end boards 18 and 20 are assembled and maintained in a rectangular assembly by the cross rails 19, 21 and corner fittings 28.

As shown in FIG. 1, the bed base 10 of the present invention is supported by feet 5 which extend downwardly from the cross rails 19, 21.

As shown in FIG. 2, the removable head and foot deck boards 24, 26, as well as center deck board 22, may be covered with padding 25 such as foam or any other suitable material. Any other panels such as those described below may likewise be covered with such padding.

In one preferred embodiment of this invention, the perimeter frame comprising the side boards and end boards are made of 7½″ high by ¾″ thick solid wood panels, or wood comprise materials, such as plywood or particle board, or MDF (medium density fiberboard). A wooden or metal support rail 30 having a lip 34 extends around the inside periphery of the rectangular frame 32 approximately 1″ beneath the top edge of the side boards 14, 16 and end boards 18 and 20. The lip 34 of this support 30 forms a lip upon which the center deck board or panel 22 rests and is secured and upon which the head deck board 24 and foot deck board 26 rest.

The components heretofore described, other than the mattress, are all preferably made of metal, wood or wood composite materials, but they need not always be made of these materials, as other materials, such as plastic, will often suffice. As used in the specification and claims of this application, the term “wood” or “wooden” is intended to include not only solid wood materials or wood panels, but also wood composite materials, such as plywood or particle board or MDF.

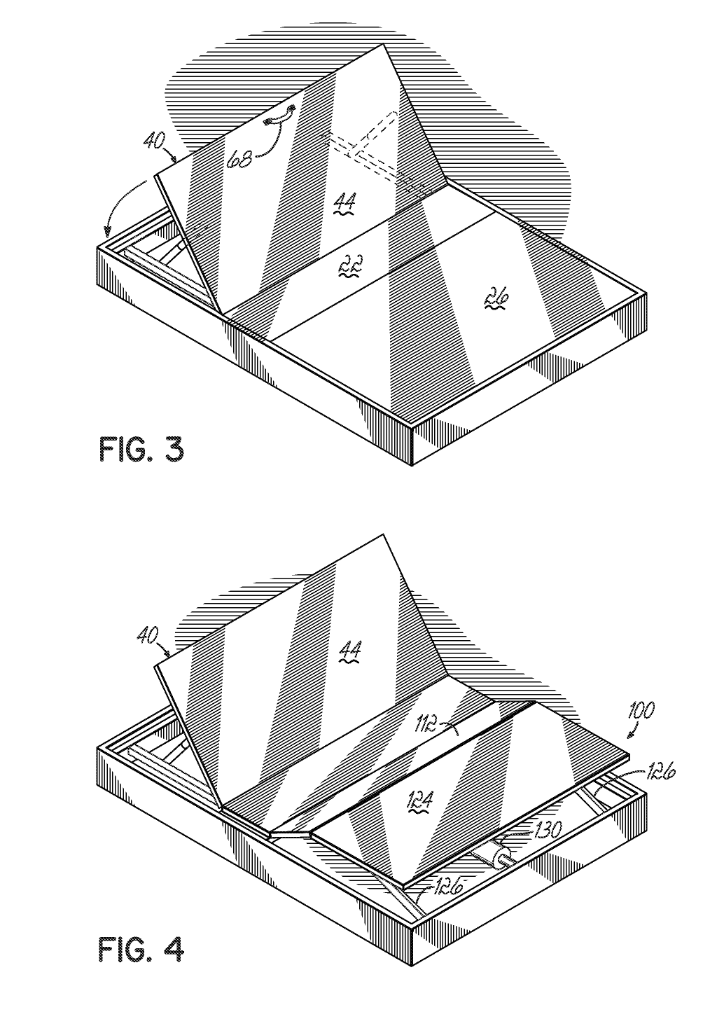

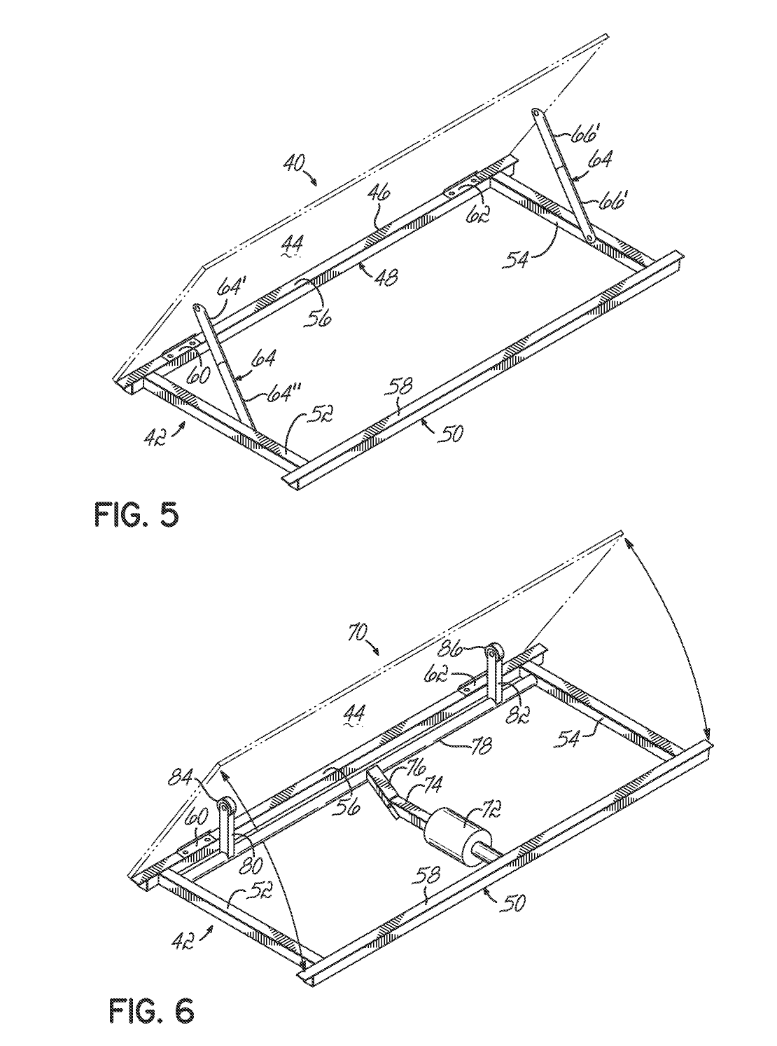

With reference now to FIGS. 3 and 5, there is illustrated an articulating adjustable head section module 40 which may be substituted in this modular bedding system for the head deck board or panel 24 in order to convert the bed base 10 from one for supporting a non-adjustable mattress 12 to one for supporting a headrest adjustable mattress. With particular reference to FIG. 5, it will be seen that the adjustable head section module 40 comprises a rectangular frame 42 pivotally connected at its forward end to a head deck board or panel 44 along one edge 46 of the head deck board or panel 44. The head deck board or panel 44 may, in fact, be the same removed head deck board 24, as was removed from the base 10 in order to enable the adjustable head section module 40 to be substituted for the head deck panel 24.

The frame 42 is preferably a metal frame made from angle iron. It comprises a front bar 48, a rear bar 50, and a pair of side bars 52, 54, all welded together, or otherwise fixedly secured together so as to create a rectangular frame. The front and rear bars 48 and 50 have a top horizontal flange 56, 58, respectively, which rests upon the top surface 30 of the lips 34 so as to support the module 40 in the base 10 after removal of the head deck board 24 from that panel.

In order to accommodate articulated or pivotal movement of the head deck board or panel 44 relative to the frame 42, the head deck panel 44 is pivotally connected by conventional hinges 60, 62 secured to the top flange 56 of the front bar 48 and the forward underside surface of the head deck panel 44 near the head end of that board. These hinges 60, 62 may be conventional piano hinges or any other conventional type of hinge which permits articulated pivotal movement between the head deck panel 44 and the front bar 48.

Extending between the underside surface of the head deck board or panel and the side bars 52, 54, there are a pair of conventional ratchet mechanisms 64, 66. Each of these ratchet mechanisms 64, 66 comprises two pivotally interconnected bars 64′, 64″, 66′, 66″, which are pivotally connected to the underside of the head deck board or panel 44 and to the side bars 52, 54, respectively. These pivotally interconnected bars 64′, 64″ and 66′, 66″ function as a ratchet mechanism to enable the head board or panel 44 to be manually lifted upwardly from a position resting atop the side bars 52, 54 to an angled position and then maintained in that position by the ratchet part of the mechanism 64, 66. Two such conventional articulating ratchet mechanisms suitable for this application are manufactured by Hettich/Franke Company and identified as that company's “Multiflex F” mechanism and “Rasto S” mechanism.

In order to convert the bed frame 10 from one for supporting a flat, non-adjustable mattress to one for supporting an adjustable mattress, all that is required is to remove the head deck board 24 from its position resting atop the supports 30 and replacing that head deck board or panel 24 with the head section adjustable module 42 shown in FIG. 5. Thereafter, whenever the mattress is to be adjusted so as to lift the head end of the mattress upwardly and place a person supported on the mattress in a position in which their head is up for purposes of reading or watching television, etc., all that is required is for the person to grip a lifting device, such as a handle or strap 68 (see FIG. 3) secured to the top surface of the head deck panel 44 and lift that panel to the desired angled position. To return the mattress to a flat or horizontal condition, all that is then required is to lift the handle and deck slightly and then drop the head deck panel 44 back into a horizontal position resting atop the top surface of the side bars 52, 54.

With reference now to FIG. 6, there is illustrated a motorized version of the articulating adjustable head section module. This FIG. 6 modification is substantially identical to the manually operated articulating adjustable head section module 40 of FIG. 5, the difference being that the motorized module 70 utilizes a motor to lift and drop the head deck panel 44 onto and off of the frame 42, as opposed to the manual version of FIG. 5, which requires that the head deck panel 44 be lifted and dropped manually from and to the side bars 52, 54. For purposes of describing this motorized modification, those portions of the articulating adjustable head section module 70 of FIG. 6, which are identical to the module 40 of FIG. 5 have been given identical numerical designations.

The adjustable head section module 70 utilizes an electric motor 72 attached to the rear frame bar 50. This motor 72 activates a worm gear (not shown) contained internally of the motor housing which in turn controls a push-pull rod 74. The push-pull rod 74 is hingedly or pivotally connected to a lever arm 76 which is, in turn, fixedly secured to a torque rod or torque tube 78. This torque tube 78 is rotatably mounted and extends between the side bars 52, 54. There are two arms 80, 82 fixed to the torque tube 78 extending beneath the underside of the head deck panel or board 44. Rollers 84, 86 are rotatably mounted on the ends of these arms 80, 82 and engage the underside of the head deck board 44. Upon activation of the electric motor 72, the push-pull rod 74 moves inwardly so as to cause the arms to move upwardly and push the head deck panel 44 upwardly. To return the head deck panel 44 to its horizontal position, the motor 72 is activated so as to push the push-pull rod 74 outwardly from the motor 72 and thereby lower the arms 80, 82 and the head deck panel 44. As is conventional in motorized adjustable beds, the motor 72 is operated and controlled either from a wired hand wand or control unit (not shown), or a wireless hand control unit or remote (also not shown). Since those controls are conventional in motorized adjustable beds, they have not been illustrated in this application.

As with the manual articulated adjustable head section module 40 of FIG. 5, the motorized articulated adjustable head section module 70 may be utilized in connection with the bed base 10 by simply again removing the head deck board or panel 24 and replacing it with the motorized module 70. The frame 42 of the module 70 then rests atop the supports 30 of the base 10 and is then operable to control adjusting movement of the head end of the mattress 12 supported atop the bed base 10.

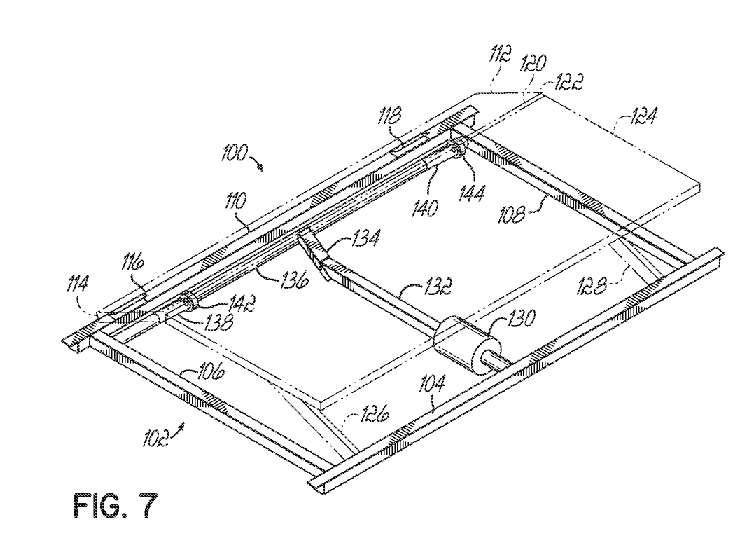

With reference now to FIGS. 4 and 7, there is illustrated a motorized articulating adjustable foot section module 100 which may be substituted for the foot deck board or panel 26 so as to convert the bed from one having a non-adjustable foot section to one having an adjustable foot section. The adjustable foot section module 100 includes a rectangular frame 102 having a rear end bar 104, a pair of side bars 106, 108, and a forwardmost or center bar 110. These bars 104, 106, 108, 110 are preferably metal and made from angle iron, which is welded or otherwise secured together to create the rectangular frame 102 so sized as to have the same overall dimensions as the removable foot deck board 26. So sized, the module 100 may be physically inserted into the frame 14 and rest atop the supports 30 of the frame upon removal of the removable deck panel 26.

In this module 100, a leg support board 112 is hingedly supported and connected at its forwardmost edge 114 to the center bar 110 by hinges 116, 118. Again, these hinges may be piano-type-style hinges or any conventional hinge which enables the leg support board or panel 112 to pivot and move relative to the center bar 110.

The rearward edge 120 of the leg support board 112 is hingedly connected by hinges (not shown) to the forward edge 122 of a foot support board or panel 124. A pair of pivoted links 126, 128 connect the underside of the foot support board 124 to the rear bar 104 of the frame 102. The links 126 are pivotally connected at their opposite or forward ends to the underside of the deck 124. These links 126, 128 function to control the elevation of the foot board or deck 124 when the foot support board 124 is moved upwardly and downwardly by a motor 130.

As shown in FIG. 7, the motor 130 and its control linkage functions very similarly to the motor 72 shown in FIG. 6 to control movement of the leg support border panel 112. At its rearward end, the motor 130 is connected to the rear bar 104 of the frame. As was the case with the motor 72, when the motor 130 is actuated, it activates a worm gear drive internally of the motor housing to move a push-pull rod 132 toward or away from the motor 130. The push-pull rod 132 is, in turn, hingedly or pivotally connected to a lever arm 134 which is in turn fixedly connected at its forwardmost end to a torque tube 136. The torque tube 136 extends between and is rotatable supported by the side bars 106, 108 of the frame 102. Also fixedly attached to the torque tube 136 are a pair of arms 138, 140, the outer ends of which support rollers 142, 144, respectively. These rollers 142, 144 engage the underside of the leg supporting board or panel 112, such that upon the push-pull rod 132 moving rearwardly, the rollers 142, 144 move over the underside of the leg support board or panel 112 and cause that board or panel 112 to be lifted upwardly. Alternatively, when the push-pull rod 132 is pushed away from the motor 130 and the rear of the frame 102, it causes the rollers 142, 144 and the arms 138, 140 upon which they are mounted to move downwardly, thereby lowering the leg support board or panel 112.

Control of the motor 130 is via a conventional wired hand wand or control unit, or a wireless remote or control unit, as is conventional with motorized adjustable beds.

In order to convert the bed base 10 from one which supports a non-adjustable flat mattress to one which supports a mattress having a foot and leg rest which may be elevated, all that is required is to remove the removable deck panel 26 from the frame 10 and replace it with the adjustable foot section module 100. Assuming that the mattress 12 is an adjustable mattress, the bed will thereby be converted from one having a non-adjustable foot section to one having an adjustable leg and foot section.

When the motorized foot section module 100 is used to replace the removable deck panel or board 26, the electric motor 130 of the module 100 is plugged into a control box (not shown) which also controls the motor of the head section module 70 and the same common hand wand (wired or wireless) is used to control operation of the foot section module 130, as well as the motor 72 of the adjustable head section module.

Another option which could be utilized with the modular bed system described hereinabove would be to add a massage unit, including an electric motor with an eccentric load on the motor attached to the underside of the articulating or adjustable deck boards 44, 124. Such a massage unit would presumably be controlled by the same remote as is used to control the motors 72, 130 of the articulating head and foot section modules. One such massage unit is described in applicant's U.S. patent application Ser. No. 11/108,995 which is fully incorporated herein.

Knock Down Bed Base

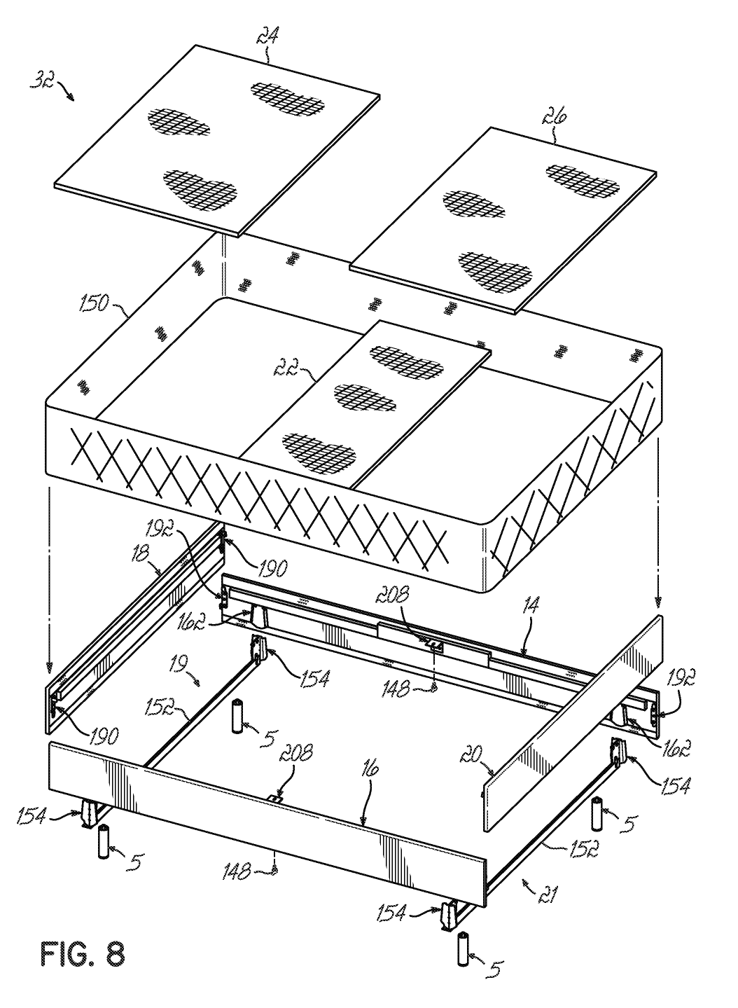

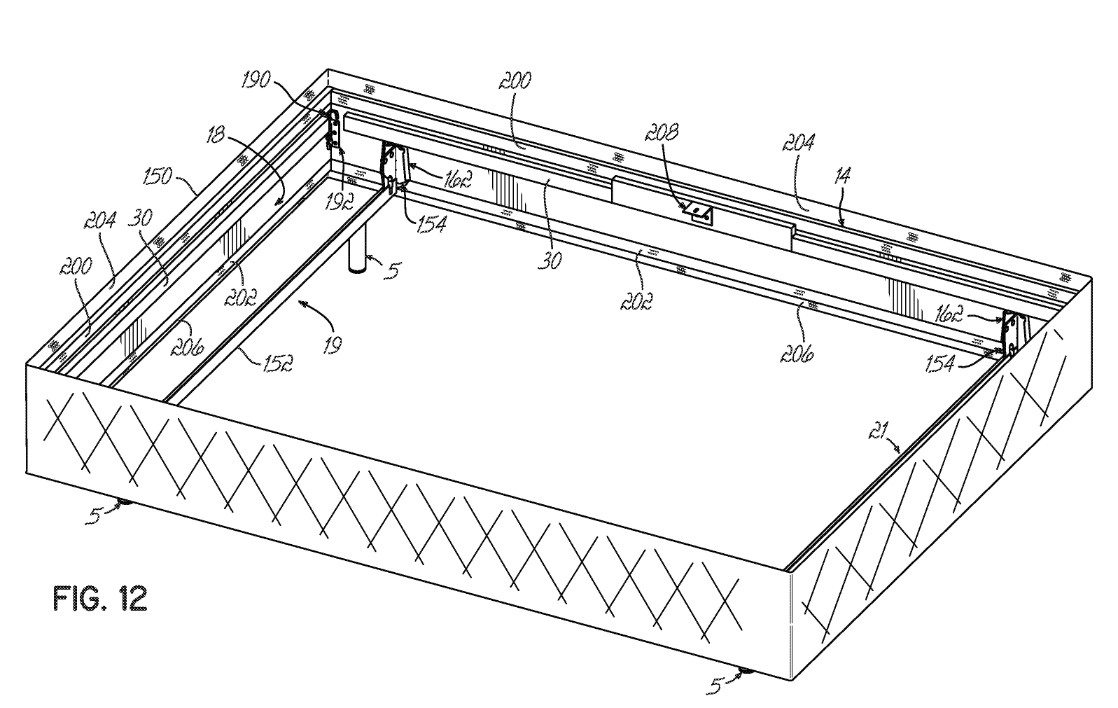

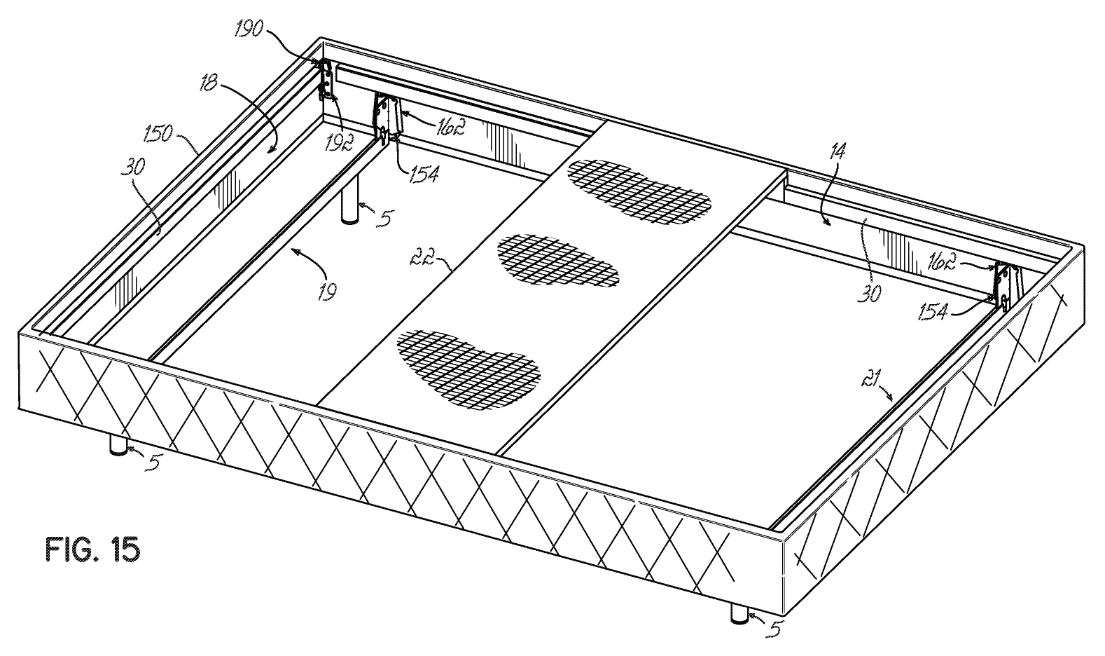

With reference now to FIGS. 8-15, the knock down bed base 10, and the manner in which it is assembled, is further illustrated. The components of the knock down rectangular frame 32 are illustrated in a disassembled kit form in FIG. 8. As there illustrated, those disassembled components comprise the side boards 14, 16, the end boards 18, 20, the cross rails 19, 21, the feet 5 which attach to the cross rails, the center panel 22, wing bolts 148, and a loop of fabric covering material 150.

Each cross rail 19, 21 comprises an angle iron body, the length of which is approximately the width of the bed frame. A wedge-shaped fitting 154 is welded, riveted or otherwise secured to each end of the angle iron body 152. As may be seen most clearly in FIG. 10, these wedge-shaped fittings 154 each comprise two sheet metal brackets 156, 156′ welded or otherwise secured back-to-back and having oppositely extending outwardly directed flanges 158, the ends of which define tapered wedges 160. These wedges 160 are generally dove-tailed in shape, with the narrower end at the top.

Again with reference to FIG. 10, it will be seen that attached near, but spaced from each end of the side boards 14 and 16, there is a wedge-shaped retainer fitting 162 which is adapted to receive and secure one of the cross rail fittings 154 to the side boards. Each wedge-shaped retainer fitting 162 comprises a sheet metal bracket 164 having opposed inwardly turned flanges 166 which define a wedge-shaped receptacle for the cross rail fittings 154.

The flat central portion of the brackets 164 are secured to the inside surface 170 of the side rails 14, 16 by conventional wooden screws 168.

As may be seen most clearly in FIG. 10, when the wedge-shaped fitting 154 at the end of each cross rail 19, 21 is inserted upwardly into the wedge-shaped retainer fitting 162 of a side rail 14, 16, the side rails are fixed in a vertical orientation relative to the cross rails 19, 21 and are locked thereto by the wedge-shaped fittings 154, 162.

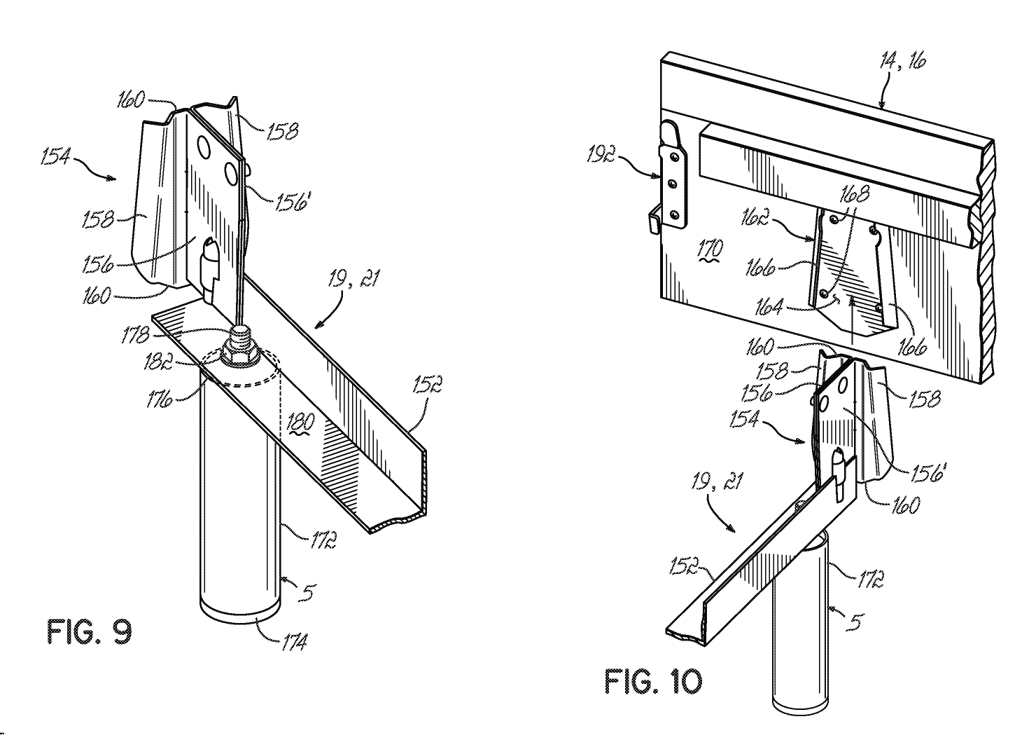

With particular reference now to FIG. 9, it will be seen that each foot 5 of the assembly comprises a central cylindrical body portion 172 having a lower supporting pad 174 and an upper closure 176. A threaded stud or captured bolt extends upwardly from the upper closure 176. As best illustrated in FIG. 9, this threaded stud or bolt 178 extends through a hole in the horizontal flange 180 of each cross rail 19, 21 and is threaded into a captured threaded nut 182 welded or otherwise secured to the top surface of the horizontal flange 180 of the cross rails. Attachment of each foot 5 to the cross rails requires only that the cylindrical body portion of the foot 5 be rotated to thread the upwardly extending stud 178 into the captured threaded nut 182 or threaded portion of the cross rail.

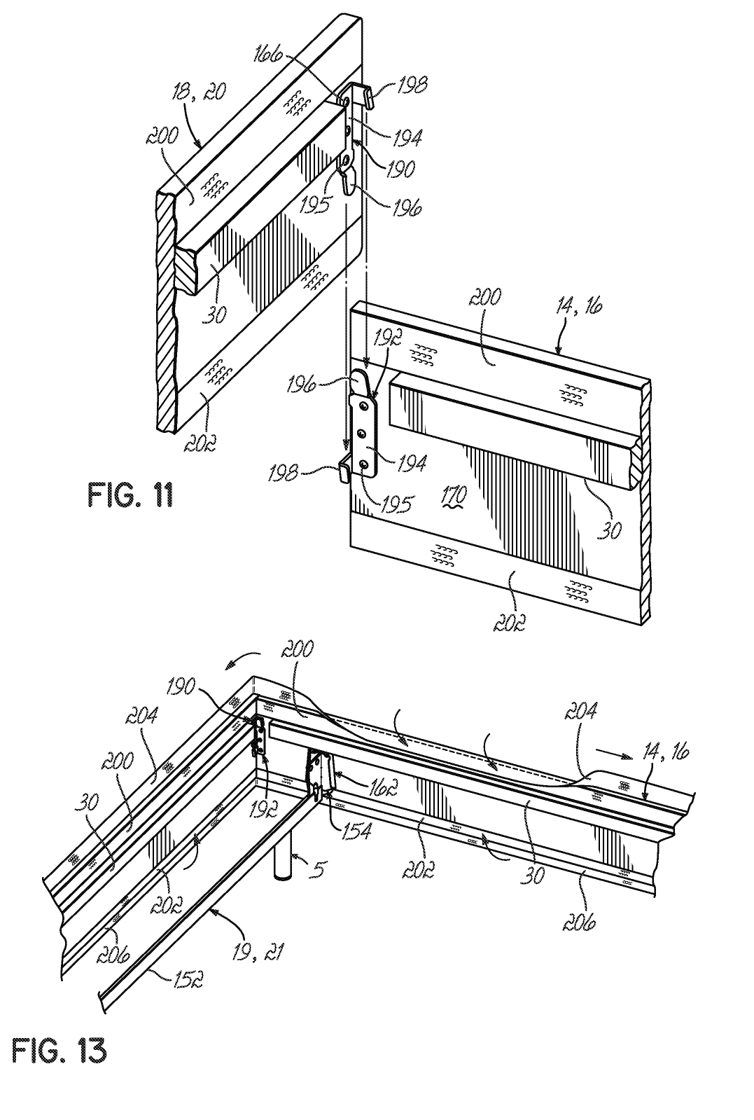

With reference now to FIG. 11, it will be seen that in order to secure the end boards to the side boards, there are mating clips 190, 192 secured to each end of each end board and each side board. These clips are identical except that they are inverted on the end boards and side boards. Each end clip 190, 192 comprises a flat base portion 194 secured by wood screws 195 to the end board 18, 20 or side board 14, 16. On each clip 190, 192, an end finger 196 extends from one end of the base portion 194 and an L-shaped flange 198 extends from the end opposite the end finger. In the case of the clips 190 attached to the end boards 18, 20, the fingers 196 extend downwardly and are offset inwardly from the plane of the flat base portion 194 of the clips. And the end fingers 196 of the clips 192 attached to the side boards 14, 16 extend upwardly and are similarly offset inwardly from the plane of the central flat body portion of the clips. To assemble the head board and the foot board to the side boards, all that is required is for the end boards and the attached clips 190 to be moved downwardly relative to the clips on the side board so as to insert the fingers 190 of the end board clips into the L-shaped flanges of the clips 192 on the side boards, thereby securing the fingers 196 on the side board clips 192 into the flanges 198 of the clips 190 on the end boards.

After the feet 5 of the frame are assembled to the cross rails 19 and 21 of the base frame, the cross rails 19, 21 are attached to the side rails 14, 16 and the end boards 18, 20 are attached to the side boards 14, 16, the assembly of the frame is completed by attachment of the fabric loop or ring 150 around the exterior of the base frame. To effect this attachment (see FIG. 13), there is a strip 200 of Velcro® hook and loop material which is glued or otherwise secured completely around the inside top edge of the side boards 14, 16 and end boards 18, 20. These strips 200 of Velcro® material are located on the inside surface of the boards extending from the top edge of the boards down to the lip 34 or top surface of the supporting rails 30. Another strip 202 of Velcro® material is also glued or otherwise secured to the inside surface of the boards adjacent the bottom edge of the end boards and side boards.

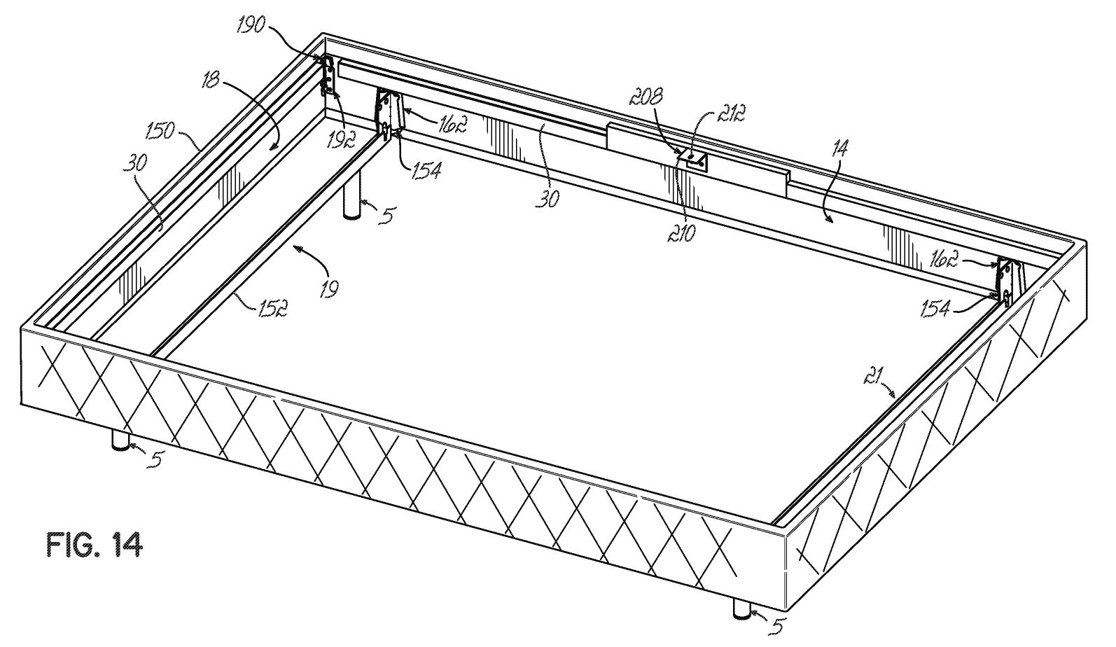

The loop of fabric material 150 is sized so as to extend completely around the outside surface of the assembled end boards and foot boards and is of a height approximately four inches greater than the height of the boards 14, 16, 18 and 20. To enable this loop of fabric material to be attached to the outside surface of these boards, there is a strip 204 of Velcro® hook and loop material sewn or otherwise secured to the top inside surface of the fabric loop 150 and similarly, another strip 206 of Velcro® hook and loop material located adjacent the bottom inside edge of the loop of fabric material 150 is sewn or otherwise secured to the inside surface of the loop of fabric material. As may be seen most clearly in FIG. 13, the fabric material is assembled around the exterior surface of the assembled end boards and foot boards by first folding the top edge of the loop of fabric material 150 over the top edge of the wood frame so as to place the strip 204 of Velcro® hook and loop material on the inside surface of the top loop of fabric material 150 in engagement with the strip 200 of Velcro® hook and loop material on the top inside edge of the side boards and end boards. Thereafter, the bottom edge of the loop of fabric material is folded over the bottom edge of the boards and upwardly to place the strip 206 of Velcro® material extending around the bottom inside surface of the loop of fabric material in engagement with the strip 202 of Velcro® hook and loop material on the end boards and side boards. The result is the assembled frame having a fabric covering extending completely over the outside surface of the assembled frame, as illustrated in FIG. 14.

As an alternative to the placement of a strip 204 of Velcro® hook and loop material completely around the top inside edge of the loop of fabric material, in some instances, the strip 204 of Velcro® material may be omitted if the strip 200 of Velcro® material on the inside upper edge of the side and end boards is Velcro® hook material. In that case, the fabric material itself may function as the loop portion of the Velcro® material and stick to the strip 200 of Velcro® hook material with sufficient tenacity to maintain the upper edge of the loop of fabric material in contact with the strip 200 of Velcro® hook material.

The completion of the assembly of the base frame then requires only the attachment of the center panel 22 to the otherwise completely assembled base frame. This requires only placement of the center panel 22 onto the support rails 30 of the side boards. To secure the center panel to the side rails, there is an L-shaped bracket 208 secured to the inside surface of each side rail. This L-shaped bracket has the vertical portion of the bracket attached as by wood screws (not shown) to the inside surface of the cross rail and an inwardly extending horizontal section 210. The inwardly extending horizontal section 210 has a slot 212 therein through which the wing bolt 148 may extend upwardly and be threaded into a captured threaded nut (not shown) secured to the underside of the center panel 22. When this wing bolt is pushed upwardly through the slot of the horizontal portion of the bracket and threaded into the captured bolt in the underside of the center panel, the center panel is locked into position on the base frame, and the base frame is now ready for reception of either the flat panels 24, 26 or the adjustable modules 40 and 70.

In the event that the bed base 10 is utilized to support a flat mattress 12 with the head panel 24 and foot panel 26 in place on the assembled frame, a slip cover-style of covering material (not shown) may be used in lieu of the loop of fabric material 150. In that event, the slip cover fabric material will fit over the complete top surface of the bed base and have ruffles or a dust cover extending downwardly on the sides of the cover over the outer surface of the head boards and side boards. In such event, an anti-skid surface covering is generally placed over the top of the covering material to prevent the mattress from sliding on the bed base.

It will be appreciated that the knock down base frame described hereinabove may be easily assembled without the use of any tools and has the advantage of being capable of being shipped in knock down condition ready for assembly by a customer with ease and without the need for complex instructions to effect the complete assembly of the base and the complete modular bed.

While we have described preferred embodiments of this invention, persons skilled in this art will appreciate changes and modifications which may be made without departing from the spirit of our invention. Therefore, we do not intend to be limited except by the scope of the following claims.

We claim:

1. A knock down bedding base, comprising:
a mattress supporting frame having two opposite facing side boards and two opposite facing end boards, each of said side and end boards having an inside surface, an outside surface and top and bottom edges;
fittings fixedly attached to the inside surface of said side boards and end boards of said frame so as to enable said end boards to be removably secured without the use of any tools to said side boards at opposite ends of said side boards;
side board support rails secured to the inside surface of said two side boards, said rails each having a top surface located beneath the top edge of said side boards;
a center deck board adapted to extend between said side boards and rest atop said top surface of said side board support rails; and
a pair of cross rails adapted to be located on opposite sides of said center deck board, said cross rails each having fittings secured to opposite ends thereof adapted to be fitted to fittings on the inside surface of said side boards so as to mount said cross rails to said side boards.

2. The knock down bedding base of claim 1 which further comprises a removable head end deck panel and a removable front end deck panel adapted to rest atop and be supported by said side board support rails.

3. The knock down bedding base of claim 1 which further comprises:
an articulating adjustable head section module;
said adjustable head section module being adapted to rest atop and be supported by said side board support rails so as to enable said bedding base to support a head end articulated adjustable mattress.

4. The knock down bedding base of claim 3 which further comprises:
an articulating adjustable foot section module;
said adjustable foot section module being adapted to rest atop and be supported by said side board support rails so as to enable said bedding base to support a foot end articulating adjustable mattress.

5. The knock down bedding base of claim 3 wherein said articulating adjustable head section module comprises a rectangular frame, an articulating head deck board pivotally secured onto one side of said rectangular frame and an adjusting mechanism for enabling said head deck board to be pivotally moved upwardly about said one side.

6. The modular bedding system of claim 5 wherein said adjusting mechanism comprises at least one racket mechanism extending between said rectangular frame and said head deck board.

7. The modular bedding system of claim 5 wherein said adjusting mechanism comprises a motor for pivotally moving said head deck board upwardly about said one side.

8. The modular bedding system of claim 5 wherein said adjusting mechanism comprises a motor for pivotally moving said head deck board upwardly about said one side;
said rectangular frame including a rotatable torque tube, said motor being mounted on said rectangular frame and being operable to rotate said torque tube;
at least one link fixedly attached at one end to said torque tube and a roller attached to the opposite end of said link, said roller being engageable with a bottom side of said deck board.

9. The knock down bedding base of claim 2 which further comprises:
an articulating adjustable head section module, said adjustable head section module being interchangeable with said head end deck panel when said bedding base is used to support an articulating adjustable mattress.

10. The knock down bedding base of claim 2 which further comprises:
an articulating adjustable foot section module, said adjustable foot section module being interchangeable with said foot end deck panel when said modular bedding system is used to support an articulating adjustable mattress.

11. The knock down bedding base of claim 1 which further comprises:
four base support feet, each of said feet comprising a cylindrical tubular body section, a top portion and a flat bottom portion, and top portion of each foot having a captured threaded element extending upwardly therefrom;
each of said cross rails having a threaded aperture at opposite ends thereof, each of said threaded apertures being adapted to receive a threaded element of one of said feet so as to enable said bedding base to be support from said feet.

12. The bedding base of claim 1 which further comprises:
a loop of fabric material adapted to be placed around the exterior of the assembled side boards and end boards and attached to the inside surface of said boards adjacent the top and bottom edges thereof.

13. The bedding base of claim 12 wherein the loop of fabric material is attached to the inside surface of said boards by one of a strip of hook and loop fastener material on the inside surface of said boards and the other of a strip of hook and loop fastener material on an inside surface of said loop of fabric material.
